(19) United States
(12) Patent Application Publication
(10) Pub. No.: US 2009/0179021 A1
(43) Pub. Date: Jul. 16, 2009

(54) Welding robot

(75) Inventors: Toshihiko Nishimura, Kobe-shi (JP); Masayuki Shigeyoshi, Fujisawa-shi (JP)

Correspondence Address: REED SMITH LLP, 3110 FAIRVIEW PARK DRIVE, SUITE 1400, FALLS CHURCH, VA, 22042, US

(73) Assignee: Kabushiki Kaisha Kobe Seiko Sho

(21) Appl. No.: 12/318,085

(22) Filed: Dec. 22, 2008

(30) Foreign Application Priority Data
Jan. 15, 2008 (JP) 2008-006026

(51) Int. Cl. B23K 9/00

(52) U.S. Cl. 219/136

(57) ABSTRACT

A welding robot in which a translational correction calculating unit corrects a target value of a leading electrode using a translational correction amount, to obtain a primary correction target value. The translational correction amount is a correction amount of a position of the leading electrode in a translational direction in a base coordinate system at a next time. A rotational correction calculating unit calculates a rotation correction amount for correcting displacement of an orientation of a torch around the leading electrode with respect to a actual weld line, and calculates a secondary correction target value resulting from correcting the primary correction target value so that the torch rotates around the leading electrode by the rotation correction amount. The displacement is caused by the correction using the translational correction amount. A manipulator is driven on the basis of the secondary correction target value.

### BACKGROUND OF THE INVENTION

1. Field of the Invention

The present invention relates to a welding robot. More particularly, the present invention relates to a welding robot that performs seam tracking when performing tandem welding.

2. Description of the Related Art

In an automatic welding apparatus, such as a welding robot, seam tracking, in which a weld line is automatically followed using various sensors, is widely used. The purpose of seam tracking is to prevent defective welding, by detecting displacement of a weld target position with a sensor and by correcting the displacement. The displacement is caused by dynamic errors in a welding operation resulting from thermal strain, a setting error, or a processing error of a workpiece. FIG. 13 schematically shows the principle of seam tracking. A sensor 1 that is used may be, for example, a mechanical sensor, a sensor utilizing a change in arc-welding current, or an optical/visual sensor. Even if the type of sensor 1 differs, a signal measured with the sensor 1 is processed with a signal processing unit 2 to detect a positional displacement δ′ between a weld joint and a torch 3, and to issue an instruction for correcting the positional displacement δ′ to a torch position controlling device 4 (which is an automatic machine, such as a robot). Accordingly, the principle is the same.

In a tandem welding method, a high-performance and high-speed welding is performed by generating arcs at two arc electrodes (welding wires) at the same time. The following types of tandem welding are available, that is, an integral-torch type and a plurality-of-torches type. In the integral-torch type, two arc electrodes 5a and 5b are provided with a common torch 6, as shown in FIG. 14A. In the plurality-of-torches type, individual arc electrodes 5a and 5b are provided with respective separate torches 6a and 6b, as shown in FIG. 14B. In general, of the two arc electrodes 5a and 5b, the one which is positioned at the front in a travel direction on a weld line is called a leading electrode (corresponding to the arc electrodes 5a in the respective FIGS. 14A and 14B), whereas the one which is positioned at the back is called a trailed electrode (corresponding to the arc electrodes 5b in the respective FIGS. 14A and 14B).

For explaining a related seam tracking that is performed when tandem welding is carried out with a welding robot, a device in which a change in an arc-welding current during a weaving operation is detected with a sensor and in which two of the sensors are provided (one for each of the two arc electrodes) is given as an example. In the related example, a path with respect to a weld line is corrected on the basis of vertical and horizontal translational components. To determine whether or not to refer to a current change of either of the two arc electrodes (that is, whether or not it is necessary to refer to a current change of a leading electrode), an operator specifies whether or not to refer to the current change of either of the two arc electrodes using, for example, a program command. Such a related seam tracking operation has the following two main problems.

Firstly, an adequate tracking ability cannot be ensured for, in particular, the trailed electrode. More specifically, defective welding occurs due to displacement of the trailed electrode after correcting a path by the tracking. As shown in FIG. 15, it is possible for an actual weld line Lre to be distorted with respect to a teaching path Lte, and for a travel direction of the torch 6, which is only corrected by a translational component, to have a rotational component with respect to a travel direction of the teaching path Lte. In this case, the leading electrode 5a correctly follows the actual weld line Lre, whereas the trailed electrode 5b is displaced from the actual weld line Lre by the positional displacement δ, thereby resulting in defective welding. The only way to overcome this problem is to reduce the correction amount resulting from the tracking. To reduce the correction amount resulting from the tracking, it is necessary, not only to increase the processing precision of a weld workpiece to be welded, but also to form a manufacturing surface so as to, for example, minimize welding thermal strain or positional displacement when setting the workpiece. Accordingly, seam tracking for essentially correcting these errors is not achieved effectively.

Secondly, the operation is troublesome to carry out, resulting in human errors. As mentioned above, in the related seam tracking operation, in determining whether or not an electrical current change of either one of the two arc electrodes is used in a tracking control, an operator specifies whether or not to use the electrical current change of either one of the two arc electrodes using, for example, a program command. However, in this method, when forming the program, the operator is forced to successively perform an input operation regarding which of the electrodes is to be selected while recognizing the welding direction. In addition, an improper tracking method in which tracking is performed on the basis of a change in current value of a trailed electrode when an input mistake is made may be selected.

### SUMMARY OF THE INVENTION

Accordingly, it is an object of the present invention to make it possible to, in a seam tracking operation during tandem welding, realize a high tracking ability, not only for a leading electrode, but also for a trailed electrode, and prevent human error without forcing an operator to perform a troublesome operation.

According to the present invention, there is provided a welding robot comprising an articulated manipulator; a welding unit including at least a torch and a welding power source, the torch being mounted to an end of the manipulator and having a pair of electrodes, and the welding power source supplying power to the electrodes; a controlling device configured to execute welding of a weld object with the welding unit while operating the manipulator so that the electrodes move along a teaching path; and sensing means for measuring positional displacements of the electrodes with respect to a position of a weld joint of the weld object during welding. The controlling device comprises target value calculating means, translational correction calculating means, rotation correction calculating means, and driving means. The target value calculating means calculates a target value of a position and an orientation of a leading electrode of the pair of electrodes in a fixed rectangular coordinate system at a next time. The translational correction calculating means calculates a translational correction amount on the basis of the positional displacement of the leading electrode measured with the sensing means, and calculates a primary correction target value. The translational correction amount is a correction amount of the position and the orientation of the leading electrode in a translation direction in the fixed coordinate system at the next time. The primary correction target value results from correcting the target value of the position and the orientation of the leading electrode using the translational correction amount. The rotation correction calculating means calculates a rotation correction amount and a secondary correction target value. The rotation correction amount is provided for correcting the positional displacement of a trailed electrode of the pair of electrodes with respect to an actual weld line. The positional displacement of the trailed electrode is caused by the correction using the translational correction amount. The secondary correction target value results from correcting the primary correction target value so that the torch rotates around the leading electrode by the rotation correction amount. The driving means drives each joint of the manipulator using a target joint angle calculated from the secondary correction target value.

By virtue of such a structure, when the welding direction is changed by a tracking control operation, not only is the position of the leading electrode corrected, but also the position of the trailed electrode is corrected.

More specifically, the rotation correction amount may be represented by the following formula:

$$Δθ = {tan}^{- 1} \frac{Δ P}{d \cdot V} ,$$

where

Δθ: ROTATION CORRECTION AMOUNT

ΔP: TRANSLATIONAL CORRECTION AMOUNT

d: WELDING-DIRECTION UNIT VECTOR

V: WELDING SPEED

In the welding robot, the sensing means may include a first sensing unit and a second sensing unit, each unit being associated with corresponding one of the pair of electrodes; the controlling device may further comprise leading electrode identifying means for identifying which of the pair of electrodes is the leading electrode on the basis of a travel direction of the torch and a torch shape parameter defining a shape of the torch and a positional relationship between the pair of electrodes; and, on the basis of an identification result of the leading electrode identifying means, the translational correction calculating means may calculate the translational correction amount using a measurement result of either one of the first sensing unit and the second sensing unit that is associated with the leading electrode.

By virtue of such a structure, either of the two electrodes is automatically identified as the leading electrode, so that seam tracking, in which, of the first and second sensing units, whichever corresponds to the leading electrode is used, is executed on the basis of the identification result.

The first and second sensing units may be current detecting sensors, optical sensors, mechanical sensors, or other types of sensors.

When the welding direction is changed by tracking, the controlling device including the rotation correction calculating means performs translational correction and a correction for rotating the torch around the leading electrode, to make it possible to achieve high tracking ability, not only for the leading electrode, but also for the trailed electrode. As a result, even when processing precision or setting precision of a weld object is low, or a dynamic error occurs during the welding due to, for example, thermal strain, it is possible to perform high-quality welding.

Since, by providing the leading electrode identifying means in the controlling device, the leading electrode is automatically identified, and the sensing unit corresponding to the leading electrode is automatically selected, an operator no longer needs to perform a troublesome operation in which the operator successively specifies a sensor that is used in a tracking control operation when forming a program as the operator does for a related welding robot. Therefore, it is possible to reliably prevent human error.

### BRIEF DESCRIPTION OF THE DRAWINGS

FIG. 1 is a schematic structural view of a welding robot according to a first embodiment of the present invention;

FIG. 2 is a block diagram of a controlling device according to the first embodiment;

FIG. 3 is a schematic view of the vicinity of an end of a manipulator;

FIG. 4 is a schematic view of a teaching program;

FIG. 5 is a flow chart for describing the operation of the welding robot according to the first embodiment of the present invention;

FIG. 6 is a flow chart for describing an identifying operation of a leading electrode;

FIG. 7 is a schematic view for describing translational correction and rotation correction;

FIG. 8 is a schematic view showing movements of the leading electrode and a trailed electrode resulting from the translational correction and the rotation correction;

FIG. 9 is a schematic view for describing the identifying operation of the leading electrode;

FIG. 10 is a schematic structural view of a welding robot according to a second embodiment of the present invention;

FIG. 11 is a block diagram of a controlling device according to the second embodiment;

FIG. 12 is a flow chart for describing the operation of the welding robot according to the second embodiment of the present invention;

FIG. 13 is a schematic view for describing the principle of seam tracking;

FIG. 14A is a schematic view of a integral-torch type;

FIG. 14B is a schematic view of a plurality-of-torches type; and

FIG. 15 is a schematic view showing positional displacement of the trailed electrode after correcting a path.

### DESCRIPTION OF THE PREFERRED EMBODIMENTS

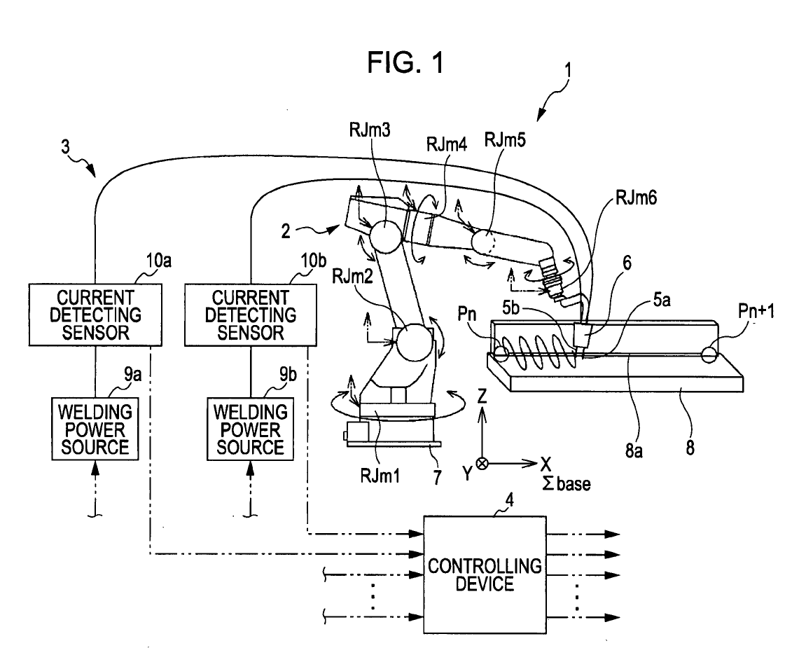

### First Embodiment (Refer to FIG. 1)

A welding robot 1 according to a first embodiment of the present invention shown in FIG. 1 comprises a manipulator 2, a welding unit 3, and a controlling device 4. The welding robot 1 automatically welds a workpiece (weld object) 8 along a weld joint 8a.

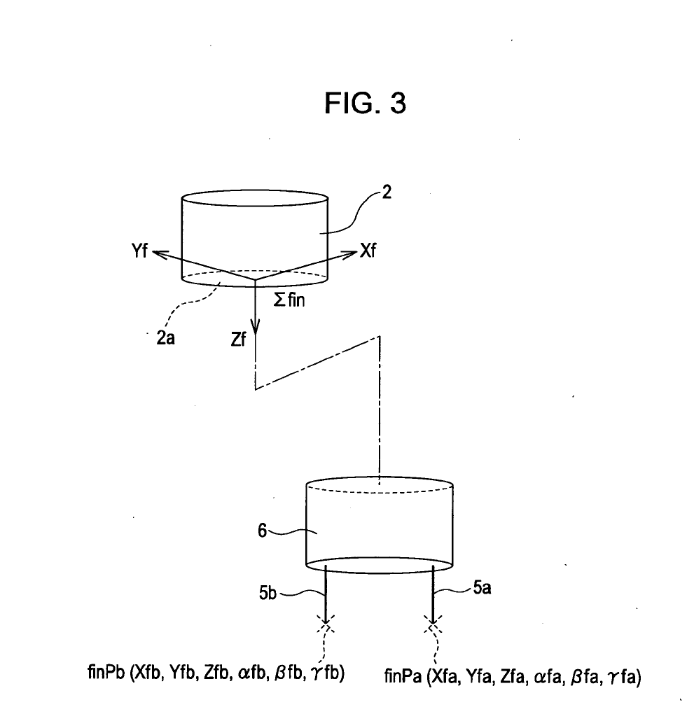

A tandem torch 6 having a pair of arc electrodes (hereafter simply referred to as “electrodes”), formed of wires, are mounted to a flange surface 2a (see FIG. 3) at an end of the manipulator 2. The manipulator 2 changes the position and the orientation of the torch 6 in three-dimensional space. The manipulator 2 has six rotational joints, RJm1, RJm2, RJm3, RJm4, RJm5, and RJm6. The rotational joints RJm1 to RJm6 are linked to each other with links, and the rotational joint RJm1 that is closest to a base end side is mounted to a base 7. The rotation joints RJm1 to RJm6 are provided with respective angle sensors for detecting motor joint angles J (J1, J2, J3, J4, J5, and J6) for rotational driving.

The welding unit 3 includes, in addition to the torch 6, welding power sources 9a and 9b for supplying power to the individual electrodes 5a and 5b. Current detecting sensors 10a and 10b are disposed between the individual electrodes 5a and 5b and the corresponding welding power sources 9a and 9b.

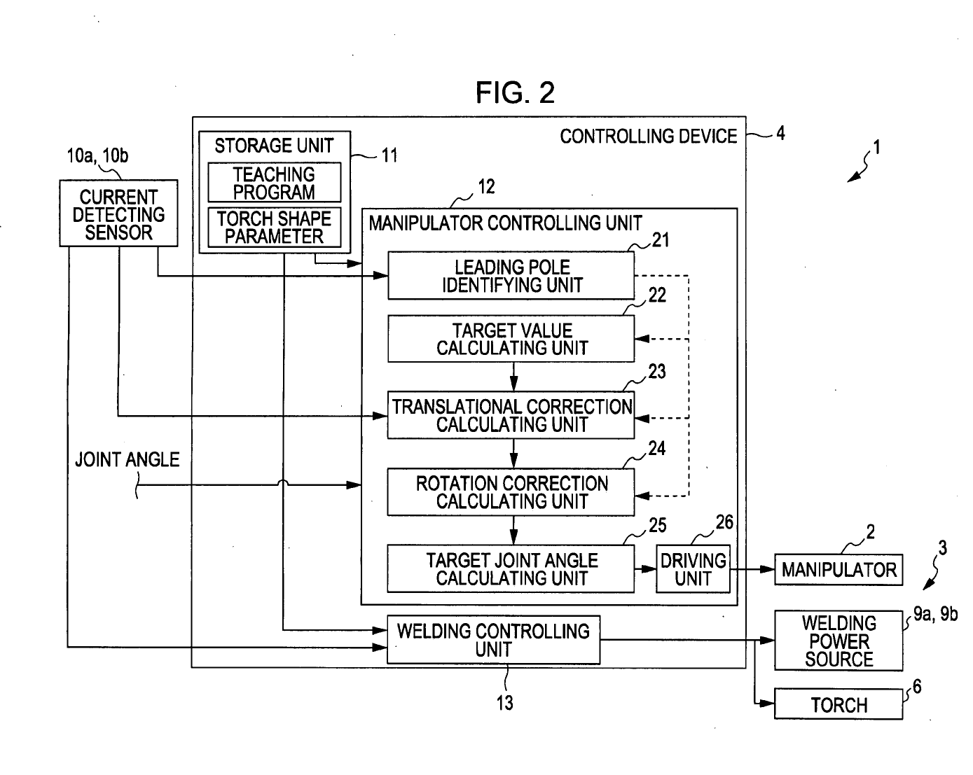

Referring to FIG. 2, the controlling device 4 comprises a storage unit 11, a manipulator controlling unit 12, and a welding controlling unit 13. The storage unit 11 stores various items of information, such as a torch shape parameter and a teaching program (described later). The manipulator controlling unit 12 drives the rotation joints RJm1 to RJm6 to operate the manipulator 2, thereby controlling the position and orientation thereof. The manipulator controlling unit 12 comprises a leading electrode identifying unit 21, a target value calculating unit 22, a translational correction calculating unit 23, a rotation correction calculating unit 24, a target joint angle calculating unit 25, and a driving unit 26. The welding controlling unit 13 controls the operation of the welding unit 3, including supply power of the welding power sources 9a and 9b and sending speeds of the wires (that is, the electrodes 5a and 5b).

Next, the coordinates used in controlling the manipulator 2 will be described. First, for the manipulator 2, a rectangular coordinate system (a base coordinate system Σbase), in which the origin is set at the base 7 for the manipulator 2 and which is fixed with respect to three-dimensional space, is set. In the base coordinate system Σbase, the position and the orientation of the manipulator 2 are expressed by baseP(X, Y, Z, α, β, γ). α denotes a roll angle, β denotes a pitch angle, and γ denotes a yaw angle. As shown in FIG. 3, for the torch 6 provided with the electrodes 5a and 5b, a rectangular coordinate system (flange coordinate system Σfln), in which the origin is fixed-to the flange surface 2a at the end of the manipulator 2, is set.

Next, controlling operations of the manipulator 2 and the welding unit 3 performed by the controlling device 4 will be described.

First, the storage unit 11 of the controlling device 4 stores a teaching program and torch shape parameters.

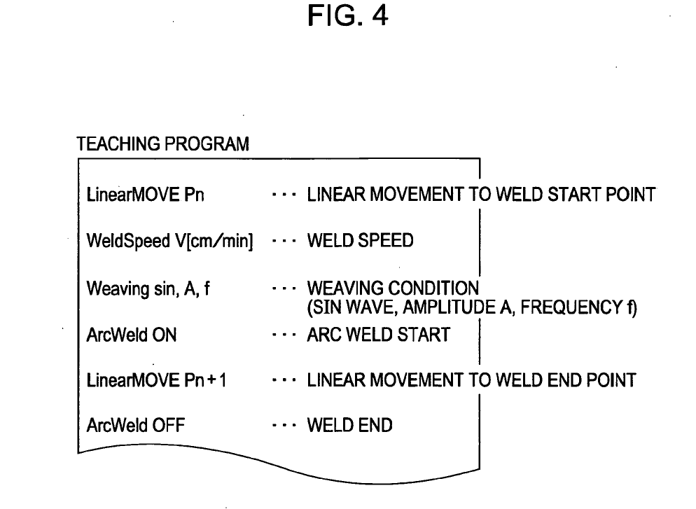

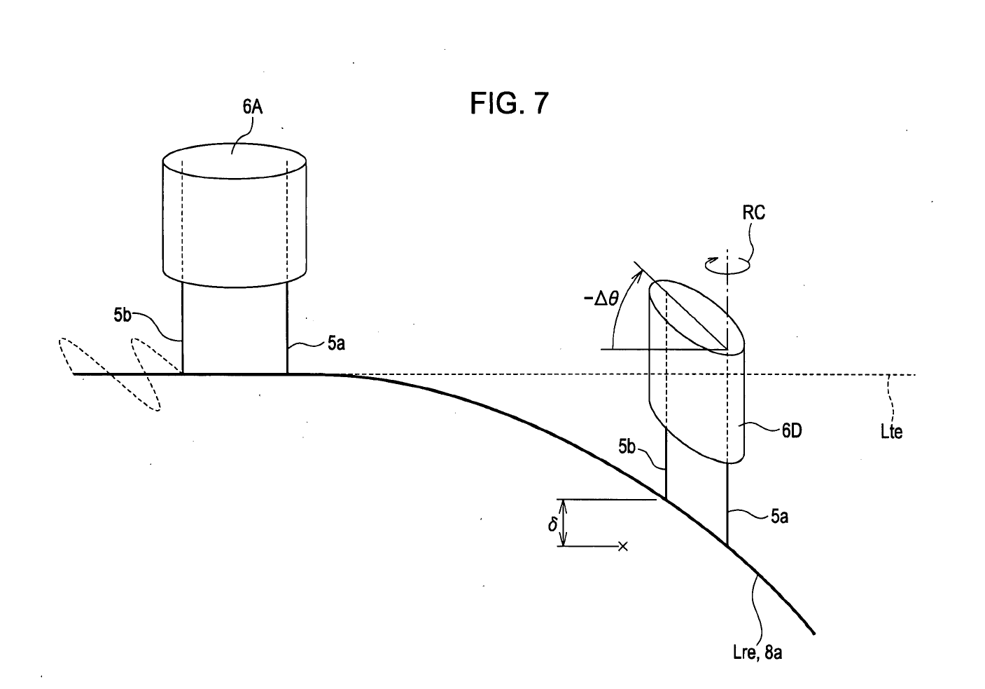

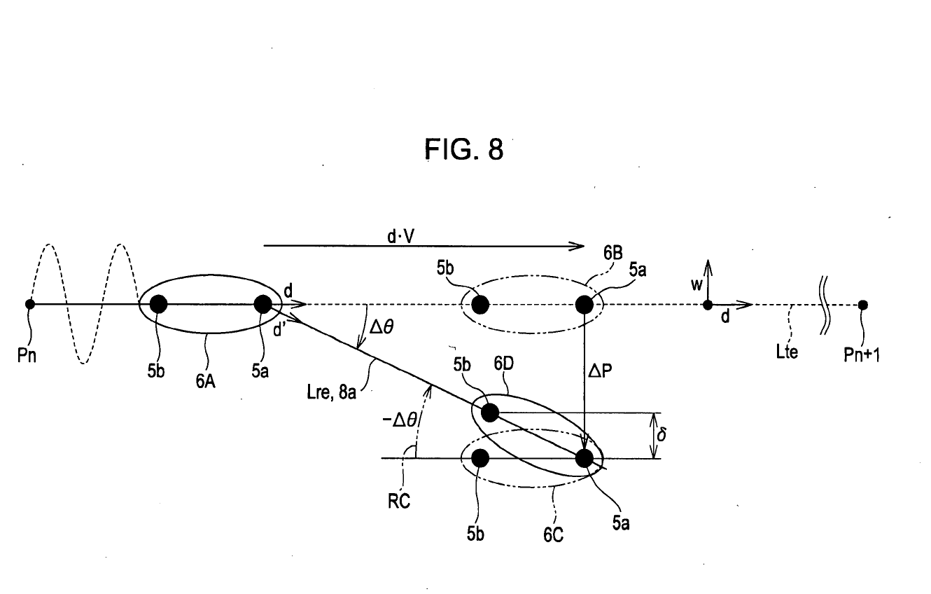

The teaching program according to the embodiment is shown in FIG. 4. The teaching program is used to cause the welding robot 1 to execute the following operations. That is, after moving the torch 6 to a weld start position Pn, the torch 6 is moved linearly at a weld speed V(cm/min) from the weld start position Pn, and executes weaving in accordance with a sine wave having an amplitude A and a frequency f, to perform welding from the weld start position Pn to a weld end position Pn+1. In the embodiment, a teaching path Lte (refer to FIGS. 7 and 8) is a straight line. However, the teaching program is only one example, so that the present invention can be executed under different conditions, such as when the teaching path is a curve.

The torch shape parameters define the positions of the pair of electrodes 5a and 5b of the torch 6, mounted to the end of the manipulator 2, with respect to the manipulator 2, and the positional relationship between the electrodes 5a and 5b. More specifically, the torch shape parameters include the positions and orientations (that is, finPa(Xfa, Yfa, Zfa, αfa, βfb, γfa)) of the electrode 5a at the flange coordinate system Σfln and the positions and orientations (that is finPb(Xfb, Yfb, Zfb, αfb, βfb, γfb) of the electrode 5b at the flange coordinate system Σfln.

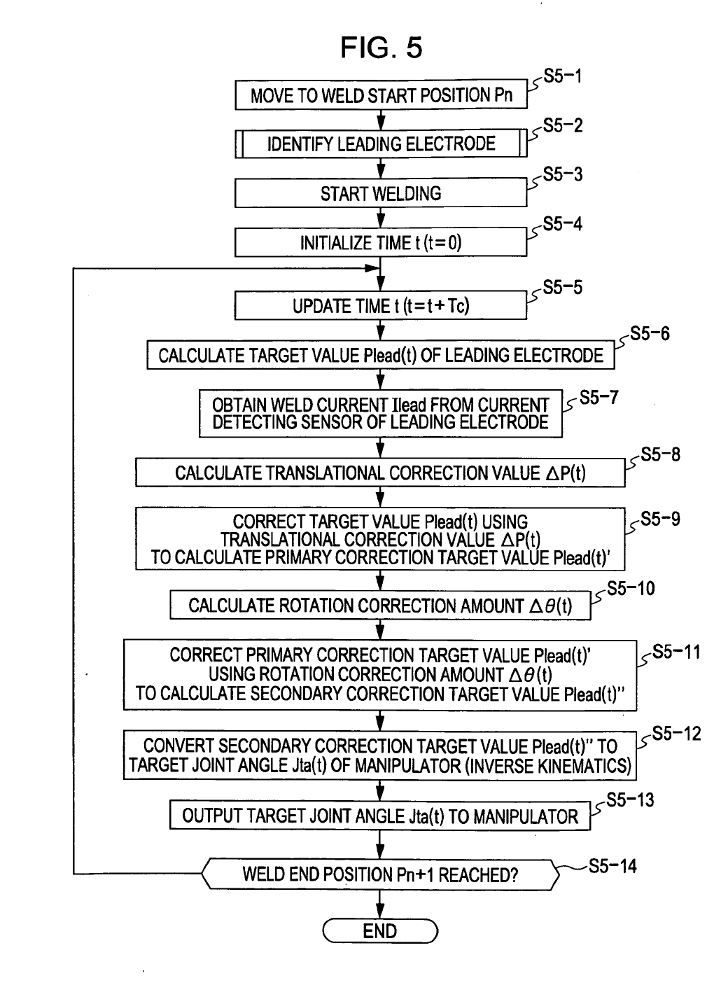

The flow chart of FIG. 5 will hereunder be referred to. First, in Step S5-1, the manipulator 2 moves the torch 6 (the end of the electrode 5a in the embodiment) to the weld start position Pn taught by the teaching program. Next, in Step S5-2, the leading electrode identifying unit 21 identifies which of the electrodes 5a and 5b is the leading electrode. For identifying the leading electrode, a unit vector (that is, a welding-direction unit vector d) that indicates a welding direction in the base coordinate system Σbase is calculated from the weld start position Pn and the weld end position Pn+1, which are taught by the teaching program. From the welding-direction unit vector (hereunder referred to as the “welding-direction vector”) d and the torch shape parameters, either the electrode 5a or 5b is identified as the leading electrode.

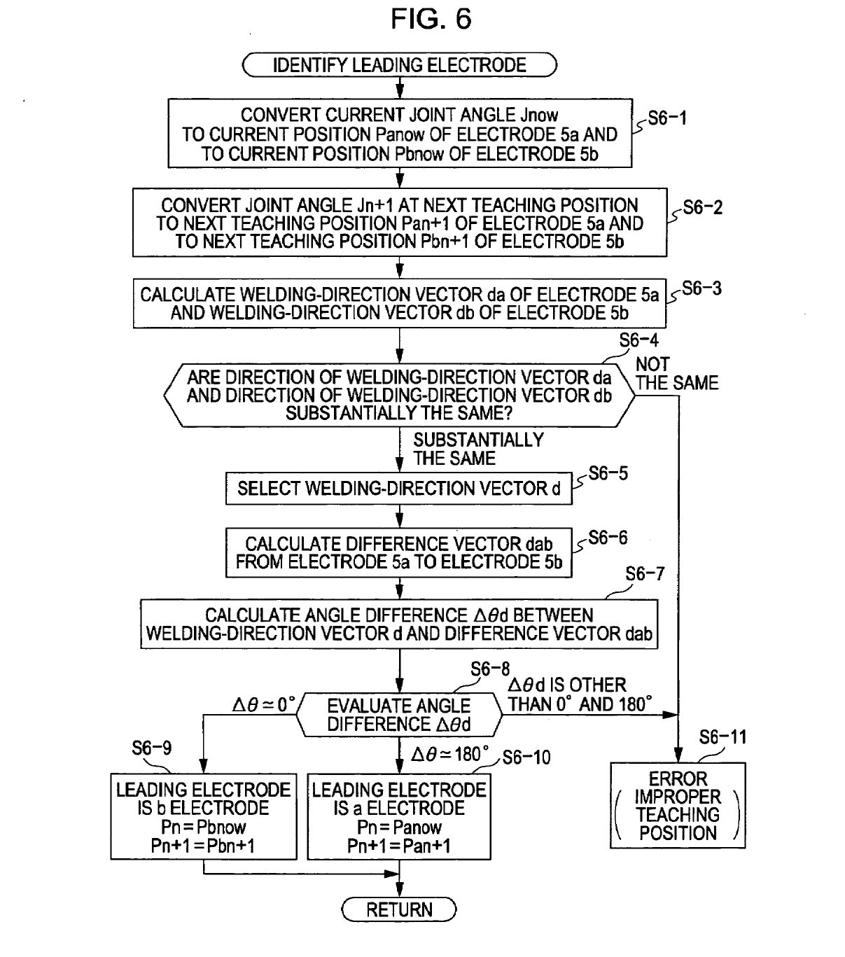

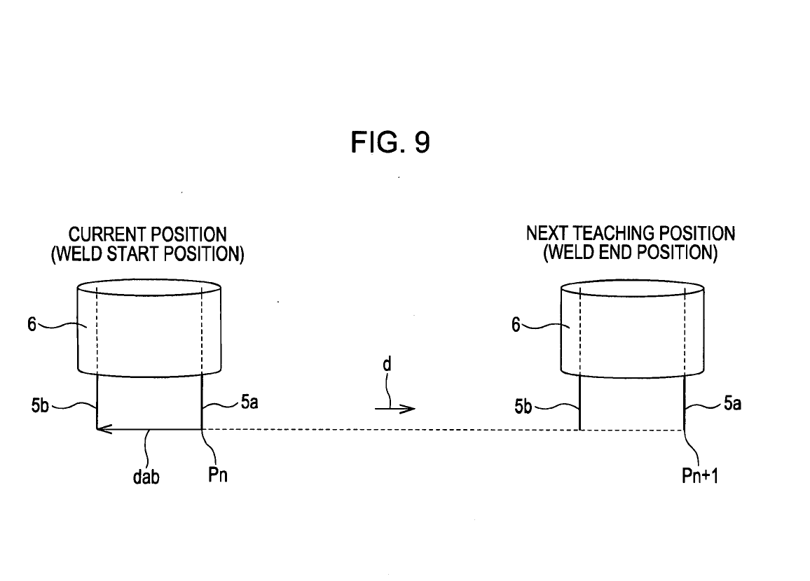

In the description of FIG. 5 below, in Step S5-2, the electrode 5a is identified as the leading electrode, and the weld start position Pn and the weld end position Pn+1 are represented on the basis of the position and orientation of the electrode 5a in the base coordinate system Σbase. The details of identifying the leading electrode and of setting the weld start position Pn and the weld end position Pn+1 due to the identification will be described below with reference to FIGS. 6 and 9. In the description regarding FIG. 5, when necessary, the electrode 5a is called the “leading electrode,” and the electrode 5b is called the “trailed electrode.” The positions and the orientations of the electrodes 5a and 5b correspond to the positions and the orientations of ends of the respective electrodes 5a and 5b.

In Step S5-3, welding is started, and, in Step S5-4, a time t is initialized (t=0). Next, the Steps S5-5 to S5-13 are repeated at every constant time interval Tc (that is, a path calculation period of the manipulator 2) until the torch 6 reaches the weld end position Pn+1, so that, while weaving of the ends of the respective electrodes 5a and 5b is performed, interpolation is executed so that the torch 6 moves linearly. First, in Step S5-5, the time t is updated to a time t+TC (next time). In FIGS. 7 and 8, reference numeral 6A denotes the position and orientation of the torch 6 (the electrodes 5a and 5b) at this time.

Next, in Step S5-6, the target value calculating unit 22 calculates a target value Plead(t) of the position and orientation of the leading electrode 5a at the time (next time) t in the base coordinate system Σbase. In the teaching program shown in FIG. 4, the target value Plead(t) is represented by the following Formula (1). In the Formula (1), an amplitude-direction vector w is a unit vector orthogonal to the welding-direction vector d, and defines the weaving direction. In FIG. 8, reference numeral 6B denotes the position and orientation of the torch 6 (the electrodes 5a and 5b) when the manipulator 2 operates on the basis of the target value Plead(t).

P_{lead}(t)=Pn+V*t*d+w*A*sin(2πf*t) (1)

P_{lead}(t): TARGET VALUE

Pn: WELD START POSITION

V: WELDING SPEED

t: TIME

d: WELDING-DIRECTION VECTOR

A: AMPLITUDE

w: AMPLITUDE-DIRECTION VECTOR

f: FREQUENCY

The translational correction calculating unit 23 executes Steps S5-7 to S5-9.

First, in Step S5-7, weld current Ilead is obtained from the current detecting sensor of the leading electrode (in the embodiment, the current detecting sensor 10a of the electrode 5a). As mentioned above, in Step S5-2, the leading electrode is automatically identified, to obtain the weld current Ilead from the current detecting sensor 10a corresponding to the leading electrode 5a that has been automatically identified.

Next, in Step S5-8, from the weld current Ilead and a weaving pattern (in the embodiment, a sine wave having an amplitude A and a frequency f), the positional displacement of the target value Plead(t) with respect to the actual weld line Lre (the actual weld joint 8a of the workpiece 8) is calculated, to calculate a translational correction amount ΔP(t) (ΔX, ΔY, ΔZ) in the base coordinate system Σbase for correcting the positional displacement (see FIG. 8). Various methods of calculating the positional displacement of the leading electrode 5a and the translational correction amount ΔP(t) at the time t are known. Such methods are discussed in, for example, Japanese Unexamined Patent Application Publication No. 58-53375. Next, in Step S5-9, the target value Plead(t) is corrected using the translational correction amount ΔP(t), to calculate a primary correction target value Plead(t)′ at the time t. The primary correction target value Plead(t)′ can be expressed by the following Formula (2):

P_{lead}(t)′=P_{lead}(t)+ΔP(t) (2)

As is clear with reference to symbol 6B in FIG. 8, if the manipulator 2 is operated on the basis of the primary correction target value Plead(t)′, that is, when a path is corrected by considering only the translational correction amount ΔP(t), the leading electrode 5a properly follows the actual weld line, but the trailed electrode 5b is displaced by the positional displacement 8 from the actual weld line Lre. Accordingly, for eliminating the positional displacement 8 of the trailed electrode 5b, the rotation correction calculating unit 24 executes Steps S5-10 and S5-11, to further correct the primary correction target value Plead(t)′.

First, in Step S5-10, a rotation correction amount Δθ(t) at time t is calculated. Referring to FIG. 8, the rotation correction amount Δθ(t) represents an angular difference between the welding-direction vector d and a welding-direction vector d′ before and after correcting the target position Plead(t) using the translational correction amount ΔP(t) (that is, the calculation of the primary correction target value Plead(t)′). In other words, the rotation correction amount Δθ(t) represents the rotational angle of the welding-direction vector d resulting from correcting the target position Plead(t) using the translational correction amount ΔP(t). As is clear with reference to FIG. 8, from geometrical relationships, the rotation correction amount Δθ(t) is expressed by the following Formula (3):

$$Δθ ( t ) = {tan}^{- 1} \frac{Δ P ( t )}{d \cdot V} \qquad ( 3 )$$

Δθ(t): ROTATION CORRECTION AMOUNT AT TIME t

ΔP(t): TRANSLATIONAL CORRECTION AMOUNT AT TIME t

d: WELDING-DIRECTION VECTOR

V: WELDING SPEED

Next, in Step S5-11, the primary correction target value Plead(t)′ is corrected using the rotation correction amount Δθ(t), to calculate a secondary correction target value Plead(t)″. More specifically, as shown by an arrow RC, the primary correction target value Plead(t)′ is corrected so that the torch 6 rotates around the leading electrode 5a by a rotation correction amount −Δθ(t) considering the sign. As is clear with reference to a symbol 6D in FIGS. 7 and 8, when the manipulator 2 is operated on the basis of the secondary correction target amount Plead(t)″, that is, when a path is corrected by considering the rotation correction amount Δθ(t) in addition to the translational correction amount ΔP(t), not only does the leading electrode 5a properly follow the actual weld line Lre, but also the trailed electrode 5b also properly follows the actual weld line Lre because the positional displacement δ is eliminated.

Next, in Step S5-12, the target joint angle calculating unit 25 calculates the inverse kinematics of the secondary correction target value Plead(t)″, to calculate the target joint angles Jta(t)(=Jta1, Jta2, Jta3, Jta4, Jta5, Jta6). Further, in Step S5-13, the driving unit 26 drives the individual rotational joints RJm1 to RJm6 of the manipulator 2 on the basis of the target joint angles Jta(t).

As mentioned above, in the welding robot 1 according to the embodiment, when the welding direction is changed due to seam tracking, correction is made to rotate the torch 6 around the leading electrode 5a in addition to making a correction in the translational direction, so that not only the leading electrode 5a, but also the trailed electrode 5b can achieve high tracking ability. As a result, even if the processing precision or the setting precision of the workpiece 8 is low, or a dynamic error occurs during welding due to, for example, thermal strain, it is possible to perform high-quality welding.

Next, with reference to FIGS. 6 and 9, the identification of the leading electrode (Step S5-2 in FIG. 5A) will be described in more detail. In an example below, a current position (weld start position) is provided on the basis of current joint angles Jnow(J1now, J2now, J3now, J4now, J5now, J6now) of the manipulator 2. In addition, a next teaching position (weld end position) is also provided on the basis of the joint angles J(J1n+1, J2n+1, J3n+1, J4n+1, J5n+1, J6n+1) of the manipulator 2.

First, in Step S6-1, the current joint angles Jnow are converted to a current position and orientation Panow of the electrode 5a and a position and orientation Pbnow of the electrode 5b in the base coordinate system Σbase. This conversion can be executed using torch shape parameters after calculating the kinematics of the current joint angles Jnow. In Step S6-2, the joint angle Jn+1 of the next teaching position is converted to a position and orientation Pan+1 of the electrode 5a and a position and orientation Pbn+1 of the electrode 5b in the base coordinate system Σbase. This conversion can also be executed using torch shape parameters after calculating the kinematics of the joint angle Jn+1.

Next, in Step S6-3, a welding-direction unit vector (welding-direction vector) da of the electrode 5a and a welding-direction unit vector (welding-direction vector) db of the electrode 5b defined by the following Formulas (4) and (5) are calculated:

$$\begin{matrix}da = \frac{Pa - Panow}{\vert Pa - Panow \vert} & ( 4 ) \\ db = \frac{Pb - Pbnow}{\vert Pb - Pbnow \vert} & ( 5 )\end{matrix}$$

Next, in Step S6-4, the dot product of the welding-direction vectors da and db is calculated, to confirm whether or not the directions of these vectors are substantially the same. If, in Step S6-4, the directions of the welding-direction vectors da and db are not the same, a determination is made that an error has occurred (that is, teaching positions Pn, Pn+1 are improper ones that cannot used), so that the process is stopped. Accordingly, when identifying the leading electrode, the properness of the teaching positions Pn and Pn+1 (that is, whether the targets of the electrodes 5a and 5b are displaced from the weld joint 8) can be confirmed. Therefore, any error in the teaching program can be previously detected before welding is started. In contrast, if, in Step S6-4, the directions of the vectors da and db are substantially the same, in Step S6-5, either one of the welding-direction vectors da and db of the respective electrodes 5a and 5b is selected, to select the representative welding-direction vector d. In the description below, the welding-direction vector da of the electrode Sa is selected as the welding-direction vector d (that is, da=d).

Next, in Step S6-6, a unit vector having a direction towards the electrode 5b from the electrode 5a in a current position (weld start position) defined by the following Formula (6) (that is, a difference vector dab between the electrodes 5a and 5b) is calculated:

$$dab = \frac{Pbnow - Panow}{\vert Pbnow - Panow \vert} \qquad ( 6 )$$

Next, in Step S6-7, the dot product of the welding-direction vector d and the difference vector dab is calculated, to calculate an angular difference Δθd between the welding-direction vector d and the difference vector dab on the basis of the dot product. In Step S6-8, either one of the electrodes 5a and 5b is identified as the leading electrode by evaluating the angular difference Δθd.

If, in Step S6-8, the angular difference Δθd is substantially 0°, that is, when the directions of the welding-direction vector d and the difference vector dab are substantially the same, the leading electrode is the electrode 5b. In this case, the weld start position Pn and the weld end position Pn+1 are set, respectively, to current position Pbnow and the next teaching position Pbn+1 of the electrode 5b, which is the leading electrode. If, in Step S6-8, Δθd is substantially 180°, that is, when the direction of the welding-direction vector d and the direction of the difference vector dab are substantially opposite to each other, the leading electrode is the electrode 5a. In this case, the weld start position Pn and the weld end position Pn+1 are set, respectively, to the current position Panow and the next teaching position Pan+1 of the electrode 5a, which is the leading electrode. If, in Step S6-8, the angular difference Δθd is neither substantially 0° nor substantially 180°, a determination is made that an error has occurred (that is, an improper teaching position is provided) in Step S6-11.

As mentioned above, by automatically identifying the leading electrode with the leading electrode identifying unit 21 of the controlling device 4 and automatically selecting either one of the current detecting sensor 10a or 10b corresponding to the leading electrode, it no longer becomes necessary to perform a troublesome operation in which an operator successively selects a sensor that is used in controlling tracking when forming a program as the operator does in a related welding robot. Therefore, it is possible to reliably prevent human error.

The current position and the next teaching position may be provided, not only on the basis of joint angles, but also on the basis of the position and orientation of the electrode 5a in the base coordinate system Σbase, the position and orientation of the electrode 5b in the base coordinate system Σbase, or a position and orientation of an intermediate portion between the electrodes 5a and 5b in the base coordinate system Σbase. In any of these cases, after identifying the leading electrode by a method similar to the method described with reference to the flow chart in FIG. 6, the current position (weld start position) and the next teaching position (weld end position) are converted to the position and the orientation of the leading electrode among the electrodes 5a and 5b. Then, using the method described with reference to the flowchart of FIG. 5, tracking control in which both the leading electrode and the trailed electrode follow the actual weld line can be executed.

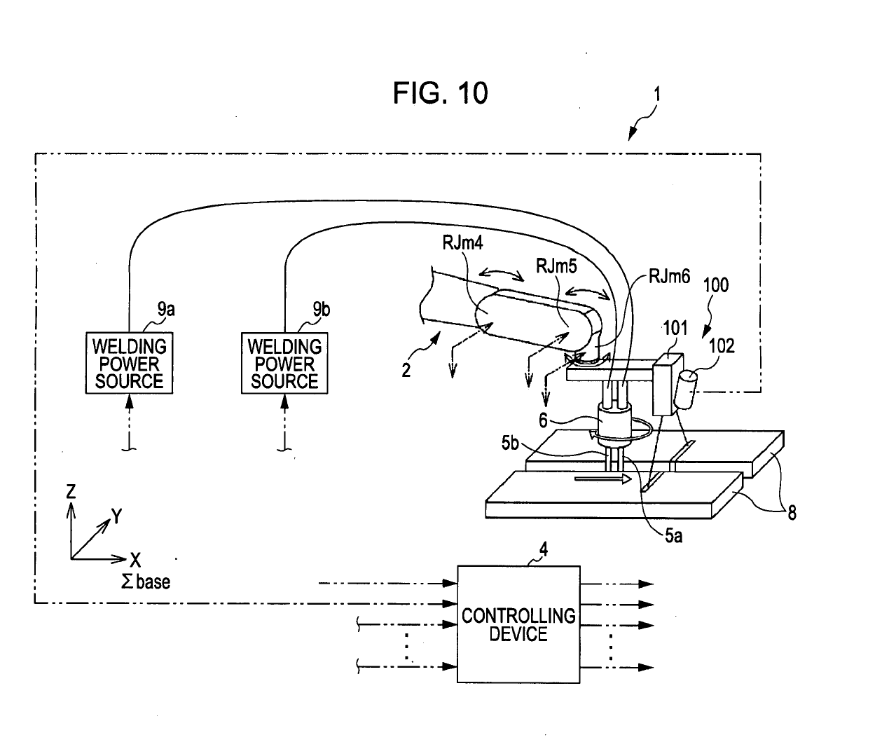

### Second Embodiment (Refer to FIG. 10)

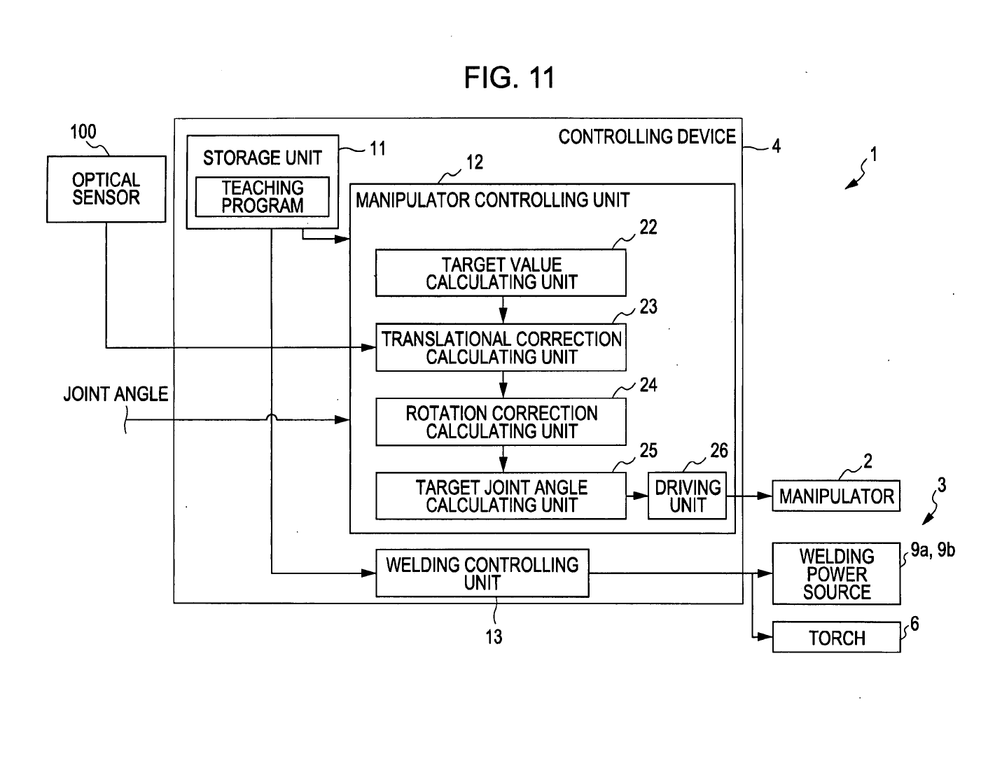

A welding robot 1 according to a second embodiment of the present invention shown in FIGS. 10 and 11 comprises an optical sensor 100 instead of the current detecting sensors 10a and 10b (see FIGS. 1 and 2). The optical sensor 100 comprises a projector 101 and a light-receiving sensor 102. In the embodiment, the leading electrode is previously known (hereunder, an electrode 5a is the leading electrode).

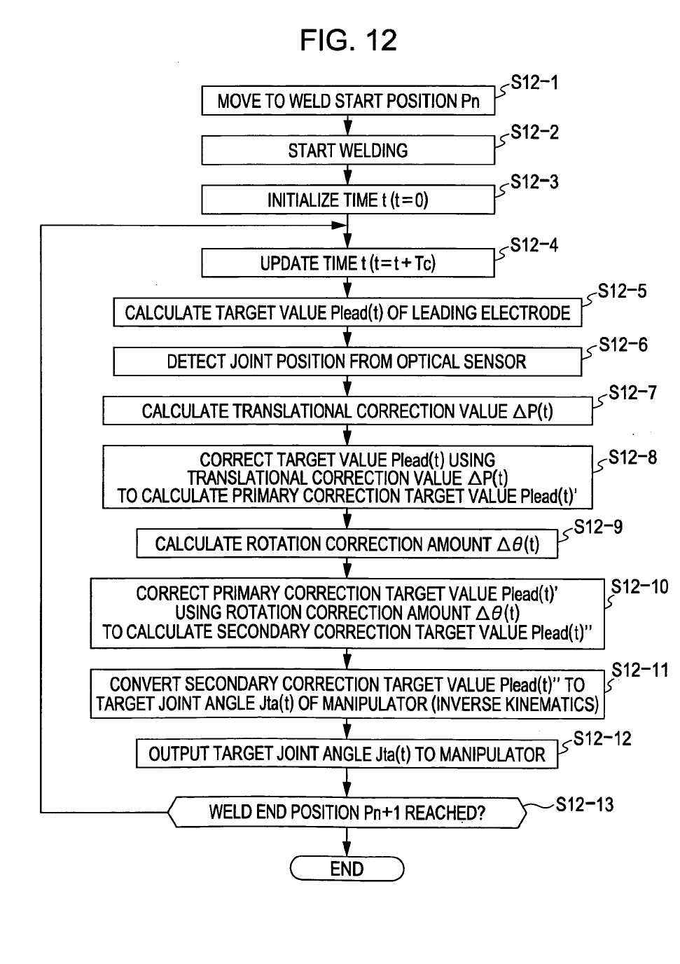

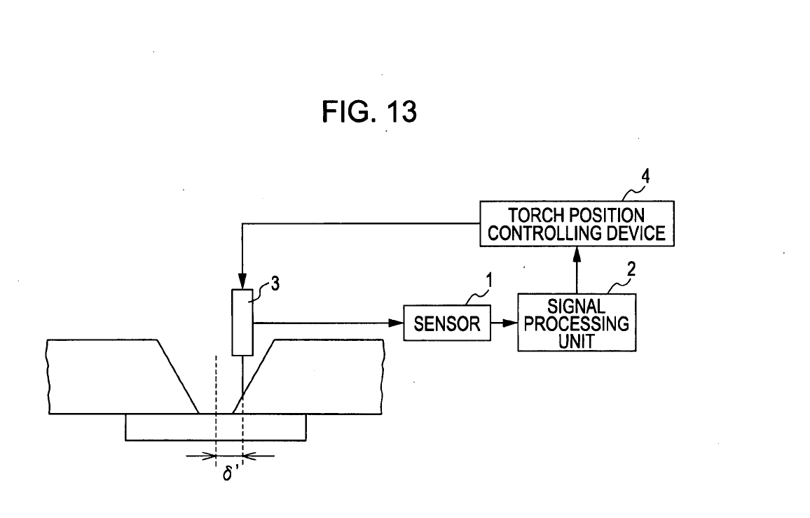

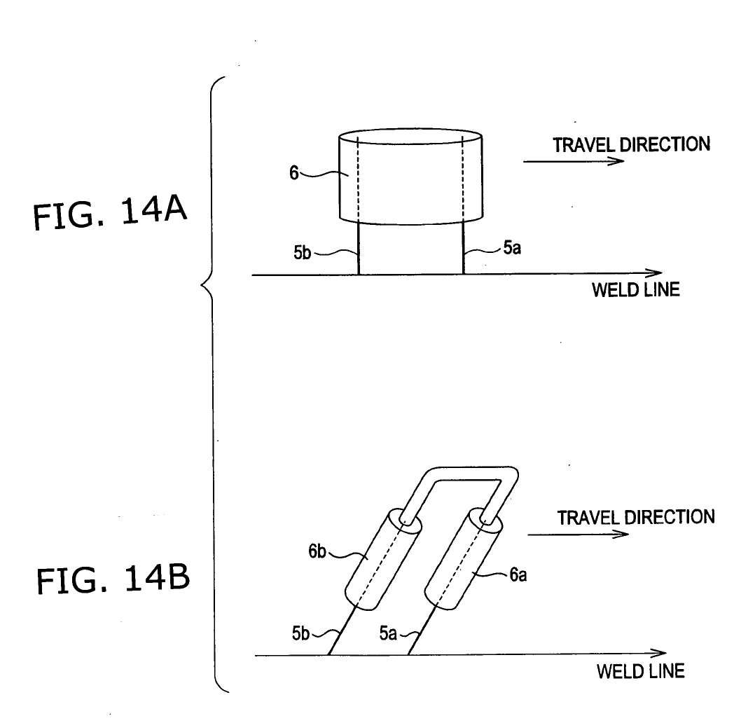

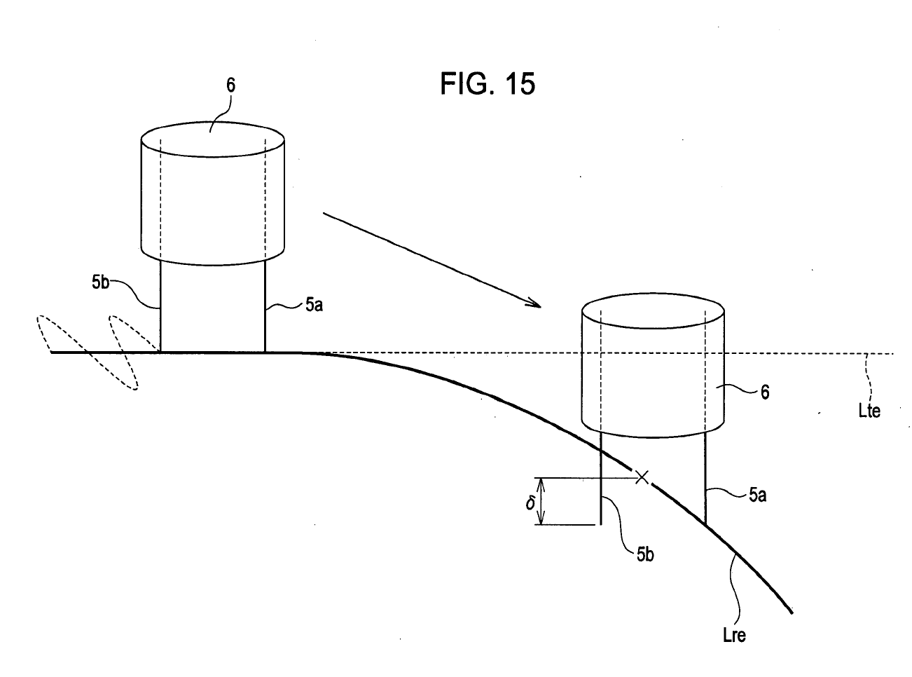

Controlling operations (Steps S12-3 to S12-13) of a manipulator 2 executed by a controlling device 4 shown in FIG. 12 are similar to those in the first embodiment in that, after starting welding by moving a torch to a weld start position Pn (Steps S12-1 to S12-2), the following operations are repeated at every path calculation interval Tc, that is, calculation of a target value Plead(t) of the leading electrode 5a, calculation of a primary correction target value Plead(t) using a translational correction amount ΔP(t), calculation of a secondary correction target value Plead(t)″ using a rotation correction amount Δθ(t), conversion of the secondary correction target value Plead(t)″ to target joint angles Jta(t), and outputting the target joint angles Jta(t) to the manipulator 2.

The second embodiment differs from the first embodiment in that a translational amount calculating unit 23 calculates a translational correction amount ΔP(t) using an image signal input from the optical sensor 100. More specifically, a workpiece is irradiated with laser slit light emitted from the projector 101, and reflection light reflected by the workpiece 8 is received by the light-receiving sensor 102. In Step S12-6, the translational amount calculating unit 23 processes the image signal input from the light-receiving sensor 102, to detect a position of a weld joint (a sensor coordinate system fixed to an end of the manipulator 2 is set, the position of the weld joint in the sensor coordinate system is, first, detected by the image processing, after which the position of the weld joint is converted to a base coordinate system Σbase). In Step S12-7, the position of the leading electrode 5a and the position of the weld joint detected with the optical sensor 100 (both of which are defined by the base coordinate system Σbase) are compared with each other, to calculate the translational correction amount ΔP(t).

The other structural features and operations according to the second embodiment are similar to those according to the first embodiment.

The present invention is not limited to the above-described embodiments, so that various modifications can be made. For example, although the present invention is described using a integral-torch-type welding robot as an example, the present invention is applicable to a plurality-of-touches type welding robot. In addition to an current detecting sensor or an optical sensor, a mechanical sensor is applicable to the welding robot according to the present invention.

What is claimed is:

1. A welding robot comprising:
an articulated manipulator;
a welding unit including at least a torch and a welding power source, the torch being mounted to an end of the manipulator and having a pair of electrodes, the welding power source supplying power to the electrodes;
a controlling device configured to execute welding of a weld object with the welding unit while operating the manipulator so that the electrodes move along a teaching path; and
sensing means for measuring positional displacements of the electrodes with respect to a position of a weld joint of the weld object during welding,
wherein the controlling device comprises:
target value calculating means for calculating a target value of a position and an orientation of a leading electrode of the pair of electrodes in a fixed rectangular coordinate system at a next time;
translational correction calculating means for calculating a translational correction amount on the basis of the positional displacement of the leading electrode measured with the sensing means, and for calculating a primary correction target value, the translational correction amount being a correction amount of the position and the orientation of the leading electrode in a translation direction in the fixed coordinate system at the next time, the primary correction target value resulting from correcting the target value of the position and the orientation of the leading electrode using the translational correction amount;
rotation correction calculating means for calculating a rotation correction amount and a secondary correction target value, the rotation correction amount being provided for correcting the positional displacement of a trailed electrode of the pair of electrodes with respect to an actual weld line, the positional displacement of the trailed electrode being caused by the correction using the translational correction amount, the secondary correction target value resulting from correcting the primary correction target value so that the torch rotates around the leading electrode by the rotation correction amount; and
driving means for driving each joint of the manipulator using a target joint angle calculated from the secondary correction target value.

2. The welding robot according to claim 1, wherein the rotation correction amount is represented by the following formula:
$$Δθ = {tan}^{- 1} \frac{Δ P}{d \cdot V} ,$$
where
Δθ: ROTATION CORRECTION AMOUNT
ΔP: TRANSLATIONAL CORRECTION AMOUNT
d: WELDING-DIRECTION UNIT VECTOR
V: WELDING SPEED

3. The welding robot according to claim 1, wherein the sensing means includes a first sensing unit and a second sensing unit, each unit being associated with corresponding one of the pair of electrodes,
wherein the controlling device further comprises leading electrode identifying means for identifying which of the pair of electrodes is the leading electrode on the basis of a travel direction of the torch and a torch shape parameter defining a shape of the torch and a positional relationship between the pair of electrodes, and
wherein, on the basis of an identification result of the leading electrode identifying means, the translational correction calculating means calculates the translational correction amount using a measurement result of either one of the first sensing unit and the second sensing unit that is associated with the leading electrode.

4. The welding robot according to claim 3, wherein the first and second sensing units are current detecting sensors.

5. The welding robot according to claim 2, wherein the sensing means includes a first sensing unit and a second sensing unit, each unit being associated with corresponding one of the pair of electrodes,
wherein the controlling device further comprises leading electrode identifying means for identifying which of the pair of electrodes is the leading electrode on the basis of a travel direction of the torch and a torch shape parameter defining a shape of the torch and a positional relationship between the pair of electrodes, and
wherein, on the basis of an identification result of the leading electrode identifying means, the translational correction calculating means calculates the translational correction amount using a measurement result of either one of the first sensing unit and the second sensing unit that is associated with the leading electrode.

6. The welding robot according to claim 5, wherein the first and second sensing units are current detecting sensors.
